(19) United States
(12) Patent Application Publication
(10) Pub. No.: US 2010/0105019 A1
(43) Pub. Date: Apr. 29, 2010

(54) Wireless-Enabled Group Motion Signals Gathering Apparatus

(75) Inventors: Tak-Wai Chan, Jung-Li City (TW); Li-Chieh Chang, Tai-Zhong City (TW); Yi-Shiang Lin, Banciao City (TW)

Correspondence Address: Jackson Intellectual Property Group PLLC, 106 Starvale Lane, Shipman, VA, 22971, US

(73) Assignee: NATIONAL CENTRAL UNIVERSITY, Taoyuan County (TW)

(21) Appl. No.: 12/650,681

(22) Filed: Dec. 31, 2009

(30) Foreign Application Priority Data
Jun. 19, 2008 (TW) 097127218

(51) Int. Cl. G09B 5/00

(52) U.S. Cl. 434/351

(57) ABSTRACT

The present invention uses motion detecting ribbons bound to moving parts of bodies. A teacher projects material on a screen. Motion statuses of students are detected by the motion detecting ribbons to be projected on the screen too. In this way, a learning environment becomes highly interactive while interactions are improved with the moving parts of bodies.

### FIELD OF THE INVENTION

The present invention relates to gathering motion statuses; more particularly, relates to providing an interactive learning environment supported with group motion statuses for improving interactions with moving parts of bodies

### DESCRIPTION OF THE RELATED ARTS

In a traditional classroom, as shown in FIG. 7, a teacher 71 and a plurality of students 72 are arranged behind their desks with chairs 73; and the teacher teaches before a black board 74. A motionless learning environment is thus formed. In such an environment, it is not supported to combine a learning activity with motions of the student. And so interactions between the teacher and the students are few.

Hence, computers are used in the classroom for interactive learning. However, only keyboard and mouse are used as input devices, which limit interactivities between the teacher and the students. As a result, not only the interactivities are limited, but also the student may not pay their attention on the material. Moreover, when the teacher watches on a monitor of his computer, he may not notice detracted students and the teaching result may not be satisfying. Hence, the prior arts do not fulfill all users' requests on actual use.

### SUMMARY OF THE INVENTION

The main purpose of the present invention is to provide ribbons for supporting interactivities in a classroom with moving parts of bodies.

The second purpose of the present invention is to provide an interactive learning place supported with motion statuses detected.

The third purpose of the present invention is to be used in a place but classroom with an interactive platform for collecting group motion statuses.

To achieve the above purposes, the present invention is a wireless-enabled group motion signals gathering apparatus, comprising a plurality of motion detecting ribbons and a group motion signals server, where each motion detecting ribbon is covered with a soft strip and has a wireless sensing chip inside; the wireless sensing chip comprises a radio-frequency (RF) transmission module, a three-dimension acceleration sensor, a programmable logic controller (PLC) and a battery; the motion detecting ribbons are bound to moving parts of learning objects to detect motion statuses for obtaining group motion signals to be transferred to the group motion signals server through a wireless electrical network; the group motion signals server is covered with a hard shell and has an RF signal receiver inside; the RF signal receiver comprises an RF receiving module, a PLC, a serial port module and a battery; the serial port module comprises an RS-232 port and a universal serial bus (USB) port; the group motion signals server is connected with a computer or a projector through the USB port of the serial port module; and the group motion signals server is connected with all of the motion detecting ribbons to collect the group motion signals through the wireless electrical network. Accordingly, a novel wireless-enabled group motion signals gathering apparatus is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the circuit view showing the motion detecting ribbon according to the preferred embodiment of the present invention;

FIG. 2 is the circuit view showing the group motion signals server;

FIG. 3 is the view showing the content of the group motion signal;

FIG. 4 is the flow view showing the client-end operation;

FIG. 5 is the flow view showing the server-end operation;

FIG. 6 is the flow view showing the state of use; and

FIG. 7 is the view of the prior art.

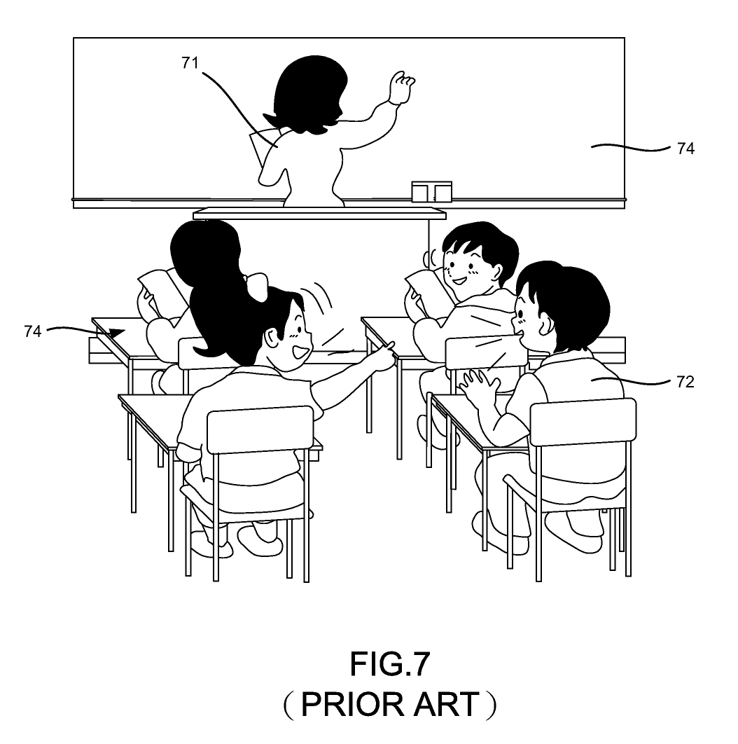

### DESCRIPTION OF THE PREFERRED EMBODIMENT

The following description of the preferred embodiment is provided to understand the features and the structures of the present invention.

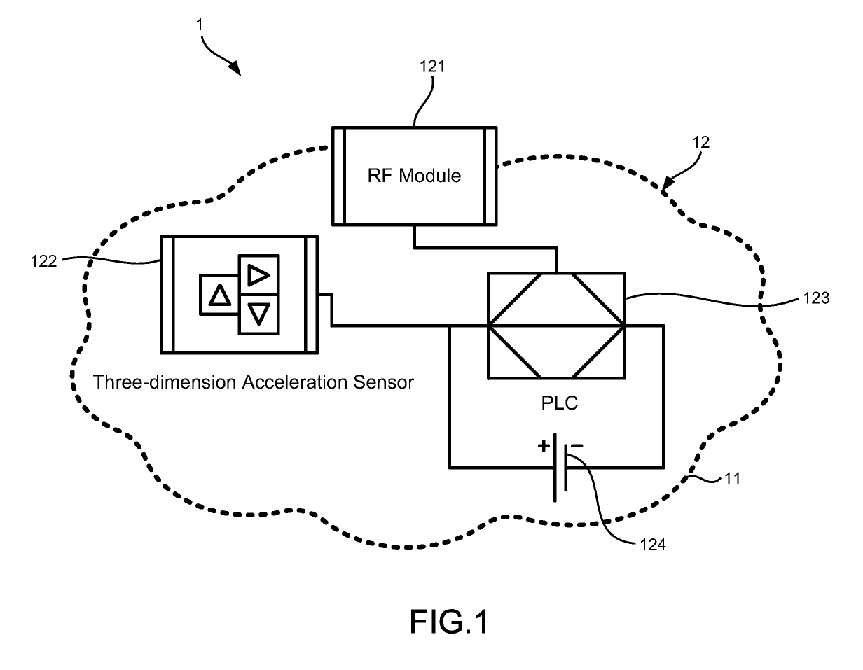

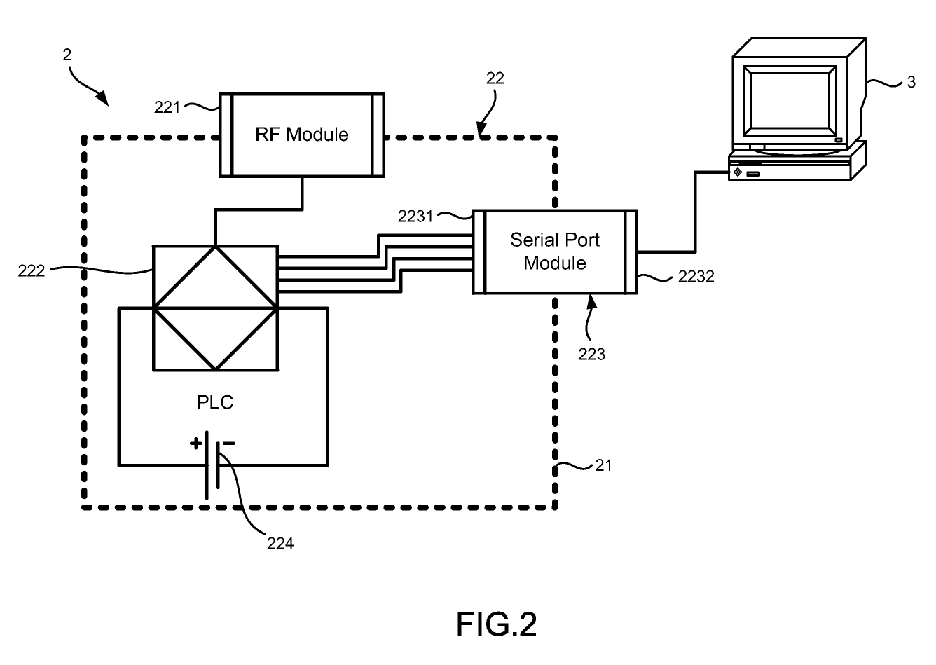

Please refer to FIG. 1 and FIG. 2, which are circuit views showing a motion detecting ribbon and a group motion signals server according to a preferred embodiment of the present invention. As shown in the figures, the present invention is a wireless-enabled group motion signals gathering apparatus, comprising a plurality of motion detecting ribbons 1 and a group motion signals server 2, where a learning environment is supported with group motion statuses for improving interactions in classroom with moving parts of bodies.

Each of the motion detecting ribbons 1 is covered with a soft strip and has a wireless sensing chip 12 inside. The motion detecting ribbons 1 are bound to the moving parts of a learning object, which is a human, a living thing or a mechanistic model. The motion detecting ribbons 1 detect motion statuses of the learning object; and thus group motion signals are obtained to be transferred through a wireless electrical network. Therein, the wireless sensing chip 12 comprises a radio-frequency (RF) transmission module, a three-dimension (3D) acceleration sensor, a programmable logic controller (PLC) and a battery.

The group motion signals server 2 is covered with a hard shell 21 and has an RF signal receiver 22 inside. The group motion signals server 2 is kept connected with all of the motion detecting ribbons 1 to collect and analyze the group motion signals sent through the wireless electrical network. Therein, the RF signal receiver 22 comprises an RF receiving module 221, a PLC 222, a serial port module 223 and a battery 224, where the group motion signals server 2 is connected with a computer 3 or a projector (not shown in the figure) through a universal serial bus (USB) port 2232 of the serial port module 223. Thus, with the above structure, a novel wireless-enabled group motion signals gathering apparatus is obtained.

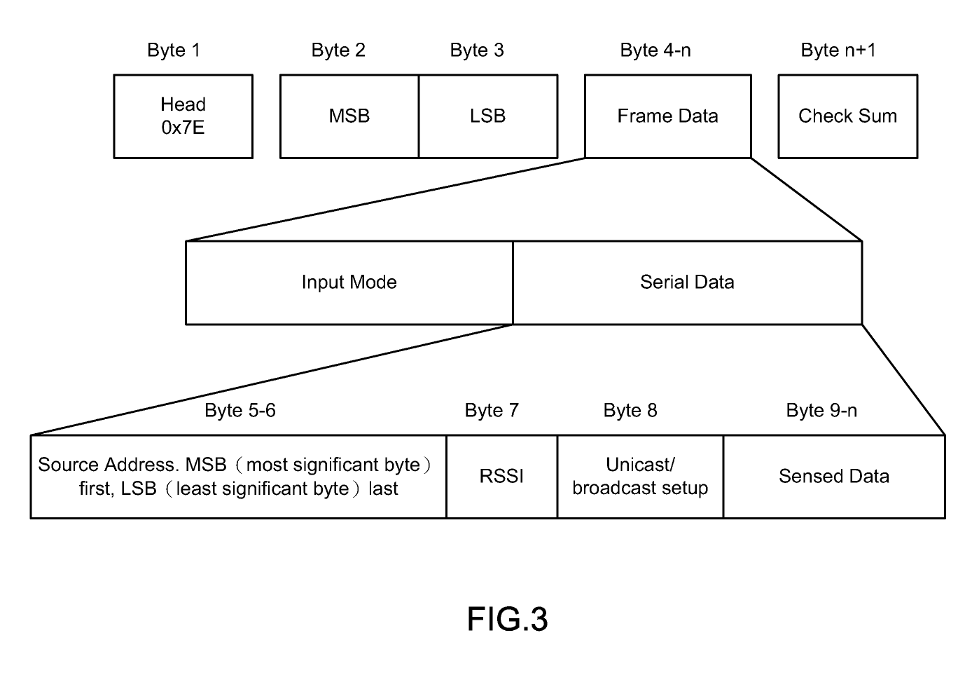

Please refer to FIG. 3, which is a view showing content of a group motion signal. As shown in the figure, motion statuses detected by motion detecting ribbons are transferred as group motion signals through a wireless electrical network. Each of the group motion signals comprises a head, a most significant byte (MSB) of package, a least significant byte (LSB) of package, frame data and a check sum, where the frame data comprises an input mode and serial data of the 3D acceleration sensor (as shown in FIG. 1); and the serial data comprises a source address, a received signal strength indication (RSSI), a unicast/broadcast setup and sensed data of the 3D acceleration sensor; and, according to IEEE802.15.4, the sensed data comprises 100 bytes of data at most.

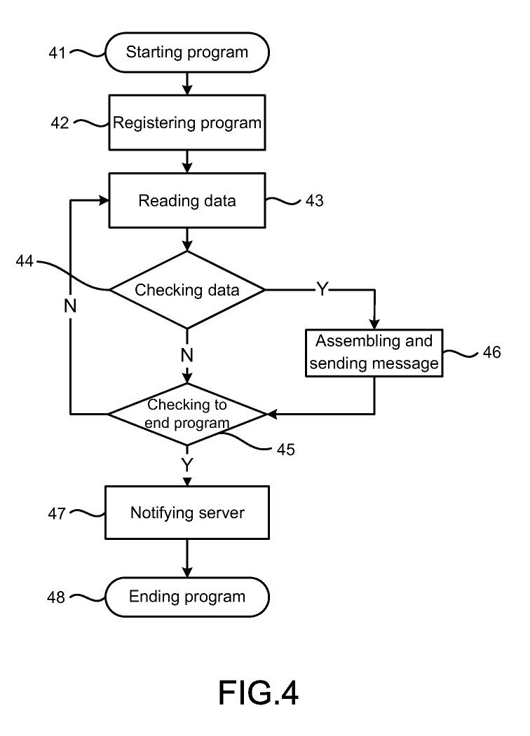

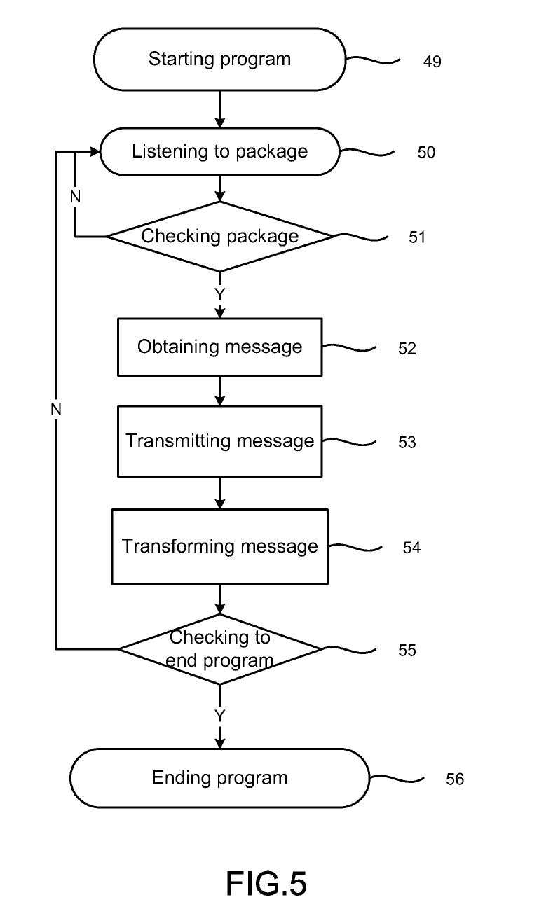

Please refer to FIG. 4 and FIG. 5, which are flow views showing a client-end operation and a server-end operation. As shown in the figures, the present invention has an operation at client end, comprising the following steps:

(a) Starting program 41: A client-end program starts.

(b) Registering program 42: The client-end program is registered to a server with a checksum byte.

(c) Reading data 43: Numeric data from a 3D acceleration sensor is read.

(d) Checking data 44: The numeric data is checked to see whether the numeric data is changed or not. If not, go to step (f).

(e) Assembling and sending message 46: A message of the change in the data is assembled into a package to be sent.

(f) Checking whether to end program 47: It is checked whether the client-end program is to be ended or not. If not, going to step (c).

(g) Notifying server 48: The server is notified to end programs in the server related to the client-end program.

(h) Ending program 49: The client-end program ends.

Thus, an operation at client end according to the present invention is done.

The present invention has an operation at server end, comprising the following steps:

(i) Starting program 49: A server-end program starts.

(j) Listening to package 50: The server-end program listens to package wirelessly sent.

(k) Checking package 51: The package sent from the motion detecting ribbon is checked. If the package is not received, go to step (j).

(l) Obtaining message 52: The package is disassembled to obtain a message.

(m) Transmitting message 53: The message is transmitted to an RS-232 port.

(n) Transforming message 54: The message is transformed into a USB signal through a serial port module; and the USB signal is then transmitted to a computer through a USB port;

(o) Checking to end program 55: The server-end program is checked whether to be ended or not. If the server-end program does not end, go to step (j).

(p) Ending program 56: The server-end program ends.

Thus, an operation at server end according to the present invention is done.

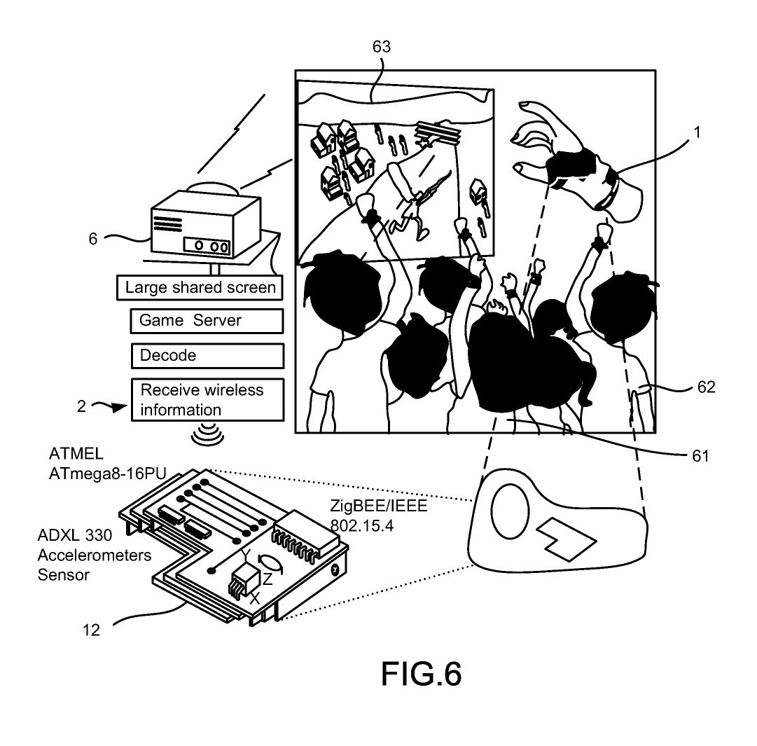

Please refer to FIG. 6, which is a flow view showing a state of use. As shown in the figure, on using the present invention, motion detecting ribbons 1 are bound to moving parts of learning objects. The motion detecting ribbons 1 detect and collect motion statuses of the moving parts for transferring group motion signals through a wireless electrical network to a group motion signals server 2 to be analyzed. Thus, a learning environment is supported with group motion statuses for improving interactions in classroom with the moving parts of bodies.

As shown in FIG. 6, an instructor and a plurality of learners 62 wear the motion detecting ribbons 1, having wireless sensing chips 12 inside, to detect motion statuses of the moving parts of the instructor 61 and the learners 62. In a learning activity, the instructor 61 uses the group motion signals server 2 and a projector 6 to project a learning material and a plurality of wirelessly received signals of moving statuses on a projector screen 63. Thus, a learning environment is supported with group motion statuses between the instructor and the learners 62.

Hence, a place for a learning activity is easily and quickly obtained, which uses the present invention to detect group motion signals of motion statuses of moving parts. By using the present invention, a motionless learning environment is turned into a learning environment supported with group motion signals of motion statuses sent wirelessly. Besides, the present invention can be also used outside of classroom, like a museum or a zoo, as an interactive platform for collecting group motion statuses.

To sum up, the present invention is a wireless-enabled group motion signals gathering apparatus, where the present invention is used in a classroom or a display place to collect group motion signals of motion statuses; the group motion signals is transferred to a server through a wireless electrical network; and, thus, a highly interactive learning environment supported with group motion statuses is obtained for improving interactions with moving parts of bodies.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A wireless-enabled group motion signals gathering apparatus, comprising:
a plurality of motion detecting ribbons, each of said motion detecting ribbons having a wireless sensing chip inside, said motion detecting ribbons being bound to a plurality of moving parts of a learning object, said motion detecting ribbons detecting motions of said moving parts to send group motion signals through a wireless electrical network; and
a group motion signals server, said group motion signals server having a radio-frequency (RF) signal receiver, said group motion signals server being kept connected with all of said motion detecting ribbons to collect and analyze said group motion signals.

2. The apparatus according to claim 1,
wherein said wireless sensing chip comprises an RF transmission module, a three-dimension (3D) acceleration sensor, a programmable logic controller (PLC) and a battery.

3. The apparatus according to claim 1,
wherein said motion detecting ribbon is covered with a soft strip

4. The apparatus according to claim 1,
wherein said learning object is selected from a group consisting of a human, a living thing and a mechanistic model.

5. The apparatus according to claim 1,
wherein said RF signal receiver comprises an RF receiving module, a PLC, a serial port module and a battery.

6. The apparatus according to claim 5,
wherein said serial port module comprises an RS-232 port and a universal serial bus (USB) port.

7. The apparatus according to claim 1,
wherein said group motion signals server is connected with a computer.

8. The apparatus according to claim 1,
wherein said group motion signals server is connected with a projector.

9. The apparatus according to claim 1,
wherein said group motion signals server is covered with a hard shell.

10. The apparatus according to claim 1,
wherein said apparatus has an operation at client end, comprising steps of:
(a) starting a client-end program;
(b) registering said client-end program to a server;
(c) reading numeric data from a 3D acceleration sensor;
(d) checking whether said numeric data is changed or not and going to step (f) on finding no change in said numeric data;
(e) assembling a message of said change into a package and sending said package;
(f) checking whether said client-end program is to be ended or not and going to step (c) on finding said client-end program does not end;
(g) notifying said server to end programs in said server related to said client-end program; and
(h) ending said client-end program.

11. The apparatus according to claim 1,
wherein said apparatus has an operation at server end, comprising steps of:
(i) starting a server-end program;
(j) listening to package;
(k) checking whether said package sent from said motion detecting ribbon is received or not and going to step (j) on finding no package is received;
(l) disassembling said package to obtain a message;
(m) transmitting said message to an RS-232 port;
(n) transforming said message into a USB signal through a serial port module and transmitting said USB signal to a computer through a USB port;
(o) checking whether said server-end program is to be ended or not and going to step (j) on finding said server-end program does not end; and
(p) ending said server-end program.

12. The apparatus according to claim 1,
wherein each of said group motion signals comprises a head, a most significant byte of package, a least significant byte of package, frame data and a check sum.

13. The apparatus according to claim 12,
wherein said frame data comprises an input mode and serial data of said 3D acceleration sensor.

14. The apparatus according to claim 13,
wherein said serial data comprises a source address, a received signal strength indication (RSSI), a unicast/broadcast setup and sensed data of said 3D acceleration sensor.

15. The apparatus according to claim 1,
wherein said apparatus is used in a room selected from a group consisting of a classroom and a room functioned as a classroom.

16. The apparatus according to claim 1,
wherein said apparatus is used in a place outside of classroom, selected from a group consisting of a museum and a zoo.
